(19) United States
(12) Patent Application Publication
(10) Pub. No.: US 2025/0269579 A1
(43) Pub. Date: Aug. 28, 2025

(54) METHOD FOR DIAGNOSING A FORMING FLUID LEAK IN A STATION FOR FORMING HOLLOW BODIES

(71) Applicant: SIDEL PARTICIPATIONS, Octeville-sur-Mer (FR)

(72) Inventor: Yves-Alban DUCLOS, OCTEVILLE-SUR-MER (FR)

(21) Appl. No.: 19/058,630

(22) Filed: Feb. 20, 2025

(30) Foreign Application Priority Data
Feb. 23, 2024 (FR) FR2401785

(51) Int. Cl. B29C 49/78; G01M 3/32

(52) U.S. Cl. CPC B29C 49/783; G01M 3/3218; B29C 2049/7831

(57) ABSTRACT

Provided is a method for diagnosing a forming fluid leak in at least one station for forming hollow bodies during a production cycle sequence. Each cycle includes a first phase of pressurizing the hollow body by connection to a source of forming fluid compressed to a maximum blowing pressure, followed by a second phase of passively maintaining pressurization during which the hollow body is isolated from the forming fluid source. The diagnostic method includes a determining the change in the pressure of the forming fluid in the hollow body by carrying out a series of multiple pressure measurements successively during the second phase.

### CROSS-REFERENCE TO RELATED APPLICATIONS

This application claims the benefit of French Application No. FR2401785, filed Feb. 23, 2024, the entire contents of which is hereby incorporated herein by reference.

### TECHNICAL FIELD OF THE INVENTION

The invention relates to a method for diagnosing a forming fluid leak in at least one station for forming hollow bodies made of thermoplastic material during a production cycle sequence, each cycle comprising a first phase of pressurizing the hollow body by connection to a source of forming fluid compressed to a maximum blowing pressure via a blowing valve, followed by a second phase of passively maintaining pressurization during which the hollow body is isolated from the forming fluid source by closure of the blowing valve, a phase of depressurizing the hollow body being triggered at the end of the phase of passively maintaining pressurization.

### TECHNICAL BACKGROUND

It is known to produce containers made of thermoplastic material, such as polyethylene terephthalate (PET), by a cycle for stretch blow molding preforms.

In general, a preform has an axisymmetrical shape. The preform comprises a neck which already has its definitive shape, whereas a body of the preform is intended to be deformed during the forming method. The main axis of the preform passes through the center of the neck. The bottom of the preform generally has a hemispherical wall centered on the main axis of the preform.

To enable its deformation, the body of the preform is heated beyond a glass transition temperature making it possible for the wall of the body to be made malleable by substantially reducing its elastic limit. By contrast, the neck is kept at a temperature lower than the glass transition temperature in order to avoid deformation thereof.

The actual forming of the preforms into final containers is effected in a forming unit comprising at least one forming station. In general, a forming unit comprises multiple forming stations in order to enable the mass production of containers. The forming unit comprises, for example, a carousel, around the periphery of which multiple forming stations are distributed.

Each forming cycle comprises a phase of gradually pressurizing the preform, during which a compressed forming fluid is injected at a maximum blowing pressure into the body of the preform so as to enable stretching of the material constituting the wall of the body of the preform in order to “inflate” the preform until it attains its definitive shape.

In order to produce containers having a substantially constant wall thickness, it is known to carry out what is referred to as biaxial stretching of the material constituting the wall of the preform in order to deform it plastically. To this end, the pressurization phase comprises a first pre-blowing subphase which is carried out prior to the injection of forming fluid at the maximum blowing pressure. During this pre-blowing subphase, a sliding stretching rod is introduced coaxially into the neck of the preform, pushing the bottom of the preform so as to stretch the wall of the body in an axial direction. In order to prevent the wall of the preform from contracting around the stretching rod during the stretching thereof, forming fluid is injected at a pre-blowing pressure lower than the maximum blowing pressure into the preform in order to start the expansion of the body toward the outside, at a distance from the stretching rod.

In general, during its forming cycle, the preform is arranged in a mold of the forming station. The mold has an impression consistent with the final container to be obtained. The wall of the body of the preform is pressed against the wall of the impression under the effect of the pressure of the forming fluid in order to give the container its definitive shape.

When it starts to deform, the preform becomes an “intermediate container” before reaching its definitive shape of “final container”.

In the remainder of the description and in the claims, the term “hollow body” will be used to denote either a preform, an intermediate container or a finished container.

During the mass production of containers, the forming stations implement numerous forming cycles at a very high frequency over long durations. For example, each forming station may implement several thousands of cycles per hour for a day.

During cycles of use of the forming station, some wearing components, such as seals, undergo gradual degradation. However, due to the manufacturing and assembly tolerances of each forming station, the rate at which the wearing components degrade can vary from one station to another. It is therefore provided to perform quite frequent maintenance operations in order to be able to replace the wearing components before this degradation affects the quality of the containers produced. Furthermore, despite the frequency of these maintenance operations, it may be the case that some wearing components degrade too rapidly, resulting in excessive consumption of pressurized forming fluid and/or in non-compliant final containers being obtained.

Furthermore, some elements of the forming station have to be adjusted depending on the preform format processed by the forming unit; this concerns for example the position of the blowing nozzle with respect to the mold. These adjustments are liable to unintentionally move over the course of numerous forming cycles implemented by the forming station. These unintentional disturbances can also result in excessive consumption of pressurized forming fluid and/or in non-compliant final containers being obtained.

There is therefore a need to effectively diagnose the condition of the forming stations during the production of containers in order to avoid having to perform excessively frequent stoppages of the forming unit in order to carry out maintenance operations.

### SUMMARY OF THE INVENTION

The invention relates to a method for diagnosing a forming fluid leak in at least one station for forming hollow bodies made of thermoplastic material during a production cycle sequence, each cycle comprising a first phase of pressurizing the hollow body by connection to a source of forming fluid compressed to a maximum blowing pressure via a blowing valve, followed by a second phase of passively maintaining pressurization during which the hollow body is isolated from the forming fluid source by closure of the blowing valve, a phase of depressurizing the hollow body being triggered at the end of the phase of passively maintaining pressurization, wherein the diagnostic method comprises a step of determining the change in the pressure of the forming fluid in the hollow body by carrying out a series of multiple pressure measurements successively during the phase of passively maintaining pressurization.

According to another feature of the method carried out according to the teachings of the invention, the step of determining the change in the forming fluid pressure is followed by a step of calculating a criterion representative of the rate of pressure drop in the hollow body during the passive maintenance phase on the basis of measurements taken during the first step of determining the change in the forming fluid pressure.

According to another feature of the method carried out according to the teachings of the invention, the second step of calculating a criterion representative of the rate of pressure drop consists in calculating the slope of a straight line defined by fitting measurements of the forming fluid pressure as a function of time.

According to another feature of the method carried out according to the teachings of the invention, the slope of the straight line is obtained by a linear regression method, such as the least squares method.

According to another feature of the method carried out according to the teachings of the invention, the value of the slope associated with said forming station during the current cycle is recorded in a memory of an electronic control unit, the method comprising a third step of calculating an average of the slopes recorded during a determined period.

According to another feature of the method carried out according to the teachings of the invention, when the criterion calculated in a cycle is representative of a pressure drop below a determined first threshold, the hollow body formed during this cycle is ejected as scrap.

According to another feature of the method carried out according to the teachings of the invention, when the average calculated during the third step of calculating an average is lower than a determined second threshold, a signal indicating a need for maintenance of the associated forming station is emitted by the electronic control unit.

According to another feature of the method carried out according to the teachings of the invention, the averages associated with said forming station are recorded in a memory of the electronic control unit, the method comprising an additional fourth prediction step in which a criterion representative of the slope of the averages as a function of time is calculated in each cycle, the electronic unit then calculating, as a function of the slope as a function of a slope of the averages, a number of cycles remaining before the average becomes lower than said second threshold.

According to another feature of the method carried out according to the teachings of the invention, the method is applied to each forming station of a forming unit comprising a plurality of forming stations, the criterion representative of the pressure drop calculated during the second step of calculating a criterion representative of the rate of pressure drop being stored in each cycle in a manner matched to an identifier of the associated forming station in order to allow individual monitoring of each forming station.

According to another feature of the method carried out according to the teachings of the invention, the average calculated during the third step of calculating an average is recorded in a memory of the electronic control unit in a manner matched to the identifier of the associated forming station.

According to another feature of the method carried out according to the teachings of the invention, during the first step, the first measurement in the series is effected after a determined delay, for example of 40 ms, from the emission of a signal for closing the blowing valve, marking the end of the pressurization phase.

According to another feature of the method carried out according to the teachings of the invention, during the first step of determining the change in the forming fluid pressure, the measurements in the series are carried out with a frequency of the order of a thousandth of a second.

According to another feature of the method carried out according to the teachings of the invention, the duration of the passive maintenance phase is at least 40 milliseconds.

According to another feature of the method carried out according to the teachings of the invention, the first step of determining the change in the forming fluid pressure in the diagnostic method comes to an end when a signal for opening a valve enabling the start of depressurization of the hollow body is emitted by the electronic control unit.

According to another feature of the method carried out according to the teachings of the invention, the pressure measurements in the first step of determining the change in the forming fluid pressure are effected by a pressure sensor which emits to the electronic control unit a signal representative of the forming fluid pressure in the hollow body.

According to another feature of the method carried out according to the teachings of the invention, the pressure sensor is arranged in a blowing nozzle of the forming station, said blowing nozzle being intended to be connected in a fluidtight manner to the hollow body during its forming.

### BRIEF DESCRIPTION OF THE FIGURES

Further features and advantages of the invention will become apparent on reading the detailed description that follows, for the understanding of which reference will be made to the appended drawings.

FIG. 1 is a view in axial section which schematically shows a station for forming a hollow body, said station being able to implement the method according to the teachings of the invention.

FIG. 2 is a block diagram which shows the different phases of a cycle for forming a hollow body in the finished container state from a hollow body in the preform state, said cycle being carried out by the forming station in FIG. 1, the ordinate axis showing the pressure and the abscissa axis showing the time.

FIG. 3 is a diagram which shows the forming fluid pressure in a preform when the forming cycle in FIG. 2 is being carried out.

FIG. 4 is a block diagram which shows the different steps of a method for diagnosing leaks that is carried out according to the teachings of the invention and applied to the forming station in FIG. 1 during multiple production cycles.

FIG. 5 is a detail view, on a larger scale, of the diagram in FIG. 2, which shows the curve during a phase of passively maintaining pressurization of the hollow body.

FIG. 6 is a schematic top view which shows a forming unit which is equipped with multiple forming stations identical to the one in FIG. 1.

FIG. 7 is a diagram which shows the values obtained by the implementation of the diagnostic method at each of the forming stations of the forming unit in FIG. 6, the ordinate axis showing the pressure drop and the abscissa axis showing the identification number of each forming station.

### DETAILED DESCRIPTION OF THE INVENTION

In the remainder of the description, similar or identical elements will be denoted by the same reference signs.

Unless mentioned otherwise, in the remainder of the description, each valve is controlled between a completely open state in which the forming fluid with a maximum flow rate and a completely closed state in which the passage of the forming fluid is prevented. Each valve is advantageously controlled automatically by an electronic control unit 50.

In the remainder of the description, the forming fluid is formed by a gas, notably air. However, the invention is also applicable to a forming fluid formed by a liquid.

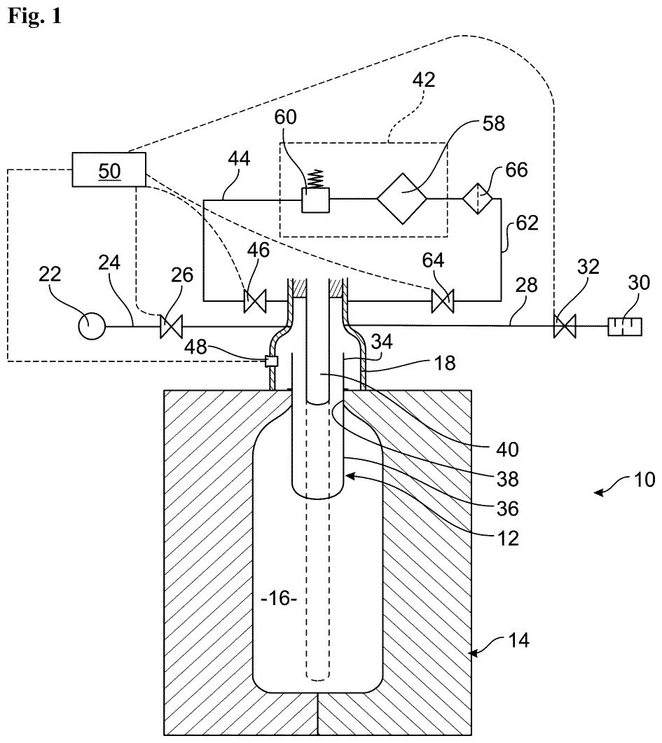

As illustrated in FIG. 1, a forming station 10 for stretch blow molding a hollow body 12, initially in the thermoplastic preform state, comprises a mold 14 forming a molding cavity 16 in two parts that are able to move apart in order to release the hollow body 12 in the final container state.

The forming station 10 further comprises a blowing nozzle 18 which is intended to be connected in a fluidtight manner with the inside of the hollow body 12 received in the molding cavity 16. The blowing nozzle 18 has, for example, the shape of a bell which caps the neck of the hollow body 12 and which bears against an upper face of the mold. A seal is advantageously interposed between the mold 14 and the blowing nozzle 18 in order to ensure a fluidtight connection of the blowing nozzle 18 to the hollow body 12.

The blowing nozzle 18 is connected to a source 22 of forming fluid at a maximum blowing pressure Pfmax, for example approximately 40 bar. The source 22 of forming fluid at the maximum blowing pressure Pfmax is connected to the blowing nozzle 18 by way of a blowing line 24 in which a blowing valve 26 is interposed.

The blowing nozzle 18 is also connected to atmospheric pressure Patm by way of an exhaust line 28. The exhaust line 28 is in this case equipped with a muffler 30. An exhaust valve 32 is interposed in the exhaust line 28.

The hollow body 12 in the preform state comprises a neck 34 and a body 36 which is preheated before being introduced into the molding cavity 16. The neck 34 in this case projects to the outside of the molding cavity 16 through an orifice 38 in the mold 14. During the stretching and blowing, the molding cavity 16 is closed around the body 36, the blowing nozzle 18 being coupled to the neck 34.

In the example shown in FIG. 1, the blowing nozzle 18 is in this case equipped with a stretching rod 40 that is vertically movable between a retracted position, shown by solid lines in FIG. 1, and an extended position shown by broken lines in FIG. 1.

By way of nonlimiting example, the blowing nozzle 18 is also connected to a source 42 of forming fluid at a pre-blowing pressure Pfp.

The source 42 of forming fluid at the pre-blowing pressure Pfp is connected to the blowing nozzle 18 by way of a pre-blowing line 44 in which a pre-blowing valve 46 is interposed.

The maximum blowing pressure Pfmax is, for example, of the order of 40 bar. The pre-blowing pressure Pfp is lower than the maximum blowing pressure Pfmax. It is for example between 6 bar and 20 bar.

The forming station 10 is intended to form a finished container from a hollow body 12 in the preform state made of thermoplastic material during a container production cycle.

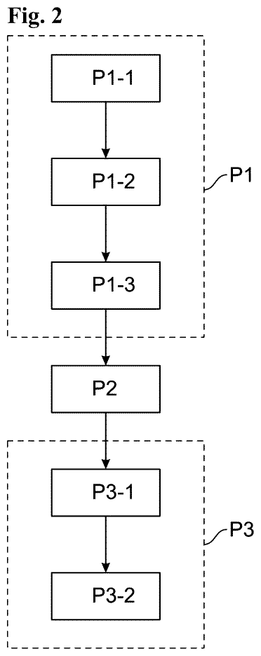

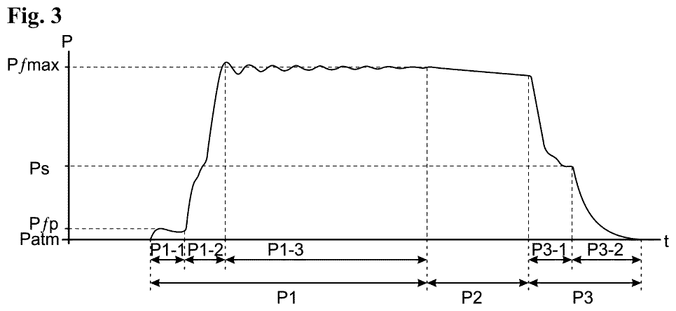

As shown in FIGS. 2 and 3, each container production cycle comprises a first phase “P1” of pressurizing the hollow body 12 during which the body 36 of the hollow body 12 is deformed by gradually increasing the pressure inside the hollow body 12. To this end, during at least a last subphase “P1-3” of this pressurization phase “P1”, the inside of the hollow body 12 is connected to the source 22 of forming fluid compressed to the maximum blowing pressure Pfmax by opening of the blowing valve 26. At the end of this pressurization phase “P1”, the hollow body 12 is filled with forming fluid at the maximum blowing pressure Pfmax.

In the example shown in the figures, the first pressurization phase “P1” comprises first of all a first pre-blowing subphase “P1-1” during which the hollow body 12 is stretched by the stretching rod 40. Simultaneously with this stretching, the blowing nozzle 18 is connected to the source 42 of forming fluid at the pre-blowing pressure Pfp by opening of the pre-blowing valve 46. This makes it possible to increase the pressure in the hollow body 12 to the pre-blowing pressure Pfp.

Then, the pre-blowing valve 46 is closed and the blowing valve 26 is opened in order to bring about a new rise in pressure of the forming fluid inside the hollow body 12 to the maximum blowing pressure Pfmax during a second blowing subphase “P1-2”.

At the end of this second blowing subphase “P1-2”, the last subphase “P1-3”, referred to as the subphase “P1-3” of actively maintaining pressurization, is triggered. During this last subphase “P1-3”, the blowing valve 26 remains open in order for the forming fluid in the hollow body 12 to be maintained at the maximum blowing pressure Pfmax for a sufficient duration to allow the hollow body 12 to retain the shape of the impression of the molding cavity 16 at the end of this pressurization phase “P1”.

It has been found that, during this subphase “P1-3” of actively maintaining pressurization, as shown in FIG. 3, the pressure of the forming fluid inside the hollow body 12 oscillates around its maximum blowing pressure value Pfmax due to resonance effects.

The first pressurization phase “P1” is followed by a second phase “P2” of passively maintaining pressurization during which the hollow body 12, then in its finished container state, is isolated from the source 22 of forming fluid at the maximum blowing pressure Pfmax by closure of the blowing valve 26. During this second phase “P2” of passively maintaining pressurization, all the valves communicating with the blowing nozzle 18 are closed so as to completely enclose the pressurized forming fluid in the hollow body 12 and in the blowing nozzle 18.

A third phase “P3” of depressurizing the hollow body 12 is triggered at the end of the second phase “P2” of passively maintaining pressurization in order to return the inside of the hollow body 12 to atmospheric pressure Patm in order to allow it to be extracted from the mold 14. During this third depressurization phase “P3”, the pressurized forming fluid is discharged, notably to the atmosphere by opening of the exhaust valve 32.

It is virtually impossible for the pressurized forming fluid to be maintained in a completely fluidtight manner in the blowing nozzle 18 and in the hollow body 12 during the second phase “P2” of passively maintaining pressurization. The forming fluid may, for example, leak at the joint face between the two parts of the mold 14 or through the means for sealing the connection between the blowing nozzle 18 and the hollow body 12, or due to a malfunctioning valve or due to a pierced line. Thus, during this phase a more or less rapid decrease in the forming fluid pressure due to leaks of forming fluid from the forming station 10 is observed.

It is necessary to rapidly identify excessively large forming fluid leaks at the blowing nozzle 18 and the hollow body 12 in order to avoid overconsumption of pressurized forming fluid.

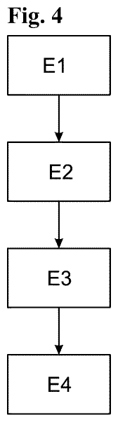

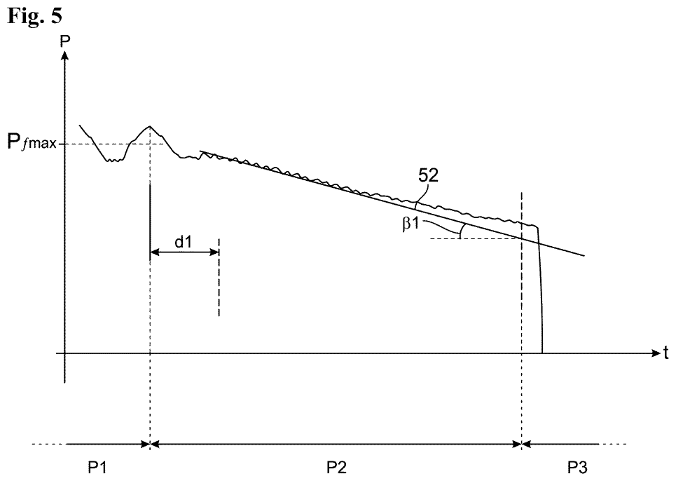

To solve this problem, the invention proposes a method for diagnosing a forming fluid leak in a forming station 10. An example of implementation of the method is shown in FIGS. 4 and 5.

This method is advantageously implemented while the forming station 10 is producing containers. This thus makes it possible to not have to interrupt the production of containers in order to carry out this diagnostic method.

The method comprises a step “E1” of determining the change in the pressure of the forming fluid in the hollow body 12 by carrying out a series of multiple pressure measurements successively during the phase “P2” of passively maintaining pressurization.

The series comprises at least two measurements, preferably more than three measurements. Advantageously, the series comprises around a hundred measurements.

The pressure measurements are in this case effected by a pressure sensor 48 which emits to an electronic control unit 50 a signal representative of the forming fluid pressure.

The pressure sensor 48 is arranged at a location which makes it possible to measure a pressure representative of the pressure inside the hollow body 12 at all times during the forming cycle, and notably during the second passive maintenance phase “P2”. The pressure sensor 48 is in this case arranged in the blowing nozzle 18 of the forming station 10.

The diagnosis of a leak is therefore applied to the hollow body 12, to the blowing nozzle 18 and to all the volumes which communicate with the nozzle 18 during the second passive maintenance phase “P2”.

During the first step “E1” of determining the change in the pressure of the forming fluid, the first measurement in the series is effected after a determined delay “d1”, for example of 40 ms, from the emission of a signal for closing the blowing valve 26 by the electronic control unit 50 at the end of the pressurization phase “P1”.

This delay “d1” is sufficient to allow the blowing valve 26 to close completely taking account of its response time.

Furthermore, this delay “d1” is preferably sufficient for the pressure oscillations due to the resonance effects to have been attenuated or even to have completely disappeared.

The duration of the passive maintenance phase “P2” is at least 40 milliseconds. Preferably, the duration of the passive maintenance phase “P2” is longer, for example of the order of a second, notably approximately 2 seconds. This duration makes it possible to collect measurements distributed over a sufficient duration to obtain a relevant indication of the change in the forming fluid pressure in the hollow body 12.

During this first step “E1” of determining the change in the pressure of the forming fluid, the measurements in the series are carried out with as high a frequency as the pressure sensor 48 permits in order to obtain a precise measurement. For example, the frequency is of the order of a thousandth of a second. This makes it possible to obtain a high number of measurements making it possible to very precisely follow the change in the forming fluid pressure in the hollow body 12. For example, the measurements are carried out every 0.4 milliseconds.

The first method step “E1” of determining the change in the forming fluid pressure comes to an end at the end of the passive maintenance phase “P2”, when a signal for opening a valve enabling the start of depressurization of the hollow body 12 is emitted by the electronic control unit 50 in order to trigger the third depressurization phase “P3”.

The step “E1” of determining the change in the forming fluid pressure is followed by a step “E2” of calculating a criterion representative of the rate of pressure drop in the hollow body 12 during the passive maintenance phase “P2” on the basis of measurements taken during the first step “E1” of determining the change in the forming fluid pressure.

The second step “E2” of calculating a criterion representative of the rate of pressure drop consists in this case in calculating a slope “β₁” of a straight line 52 defined by fitting the series of measurements taken during the first step “E1” of determining the change in the forming fluid pressure as a function of time. This second step “E2” of calculating a criterion representative of the rate of pressure drop is carried out automatically by the electronic control unit 50.

The fitting may be obtained by linear regression, in particular by the least squares method, or by other methods based for example on segmentation of values in order to use smoothing phenomena (for example the Mayer method or the median-median method).

In one exemplary embodiment, the slope “β₁” of the straight line 52 is obtained by a linear regression method, notably by the least squares method.

According to this method, each measurement “nᵢ” has coordinates:
“yᵢ” corresponding to the measured pressure;
“xᵢ” corresponding to the time at which the measurement was effected.

The number “n” represents the number of measurements effected during the series.

The slope “β₁” of the straight line 52 obtained by linear regression from all the measurements in the series will be given by the following formula: [Math 1]

$${β}_{1} = \frac{\sum {x}_{i} \sum {y}_{i} - n \sum {x}_{i} {y}_{i}}{{( \sum {x}_{i} )}^{2} - n \sum {x}_{i}^{2}}$$

Since the pressure cannot increase during this phase “P2” of passively maintaining the pressure, the slope “β₁” is necessarily negative or zero. The rate at which the pressure decreases is proportional to the slope “β₁” thus calculated. This means that if the slope “β₁” goes below a determined first threshold “S1”, this means that the hollow body 12 is probably pierced, thus causing a very rapid leak of the forming fluid and therefore a rapid pressure drop. When the electronic control unit 50 detects that the slope “β₁” thus calculated is lower than said determined first threshold “S1”, it automatically commands that the hollow body 12 formed during this cycle be ejected to scrap because it is considered to be pierced.

The forming station 10 is intended to be used to mass produce containers. Thus, the forming station 10 successively carries out numerous production cycles. It is therefore beneficial to be able to implement the diagnostic method in each cycle in order to be able to obtain a robust diagnosis of a forming fluid leak in said forming station 10. This notably makes it possible to discard the particular cases in which the pressure drop is due to a pierced hollow body 12.

To this end, the slope “β₁” associated with said forming station 10 during the current cycle is recorded in a memory of the electronic control unit 50. The diagnostic method comprises a third step “E3” of calculating an average “βₐᵥ” of the slopes “β₁” recorded during a determined period.

The determined periods are successive and do not overlap. Thus, at the end of a period of time, the electronic control unit 50 calculates the average “βₐᵥ” of the slopes “β₁” recorded during said period of time. Then a new period starts.

The determined period is in this case a period of time, for example 24 h.

In a variant, the determined period is a number of container production cycles.

When the average “βₐᵥ” calculated during the third step “E3” of calculating an average “βₐᵥ” is lower than a determined second threshold “S2”, which is for example greater than the determined first threshold “S1”, a signal indicating a need for maintenance of the associated forming station is emitted by the electronic control unit 50. This then means that the forming station 10 is subject to a forming fluid leak independently of the state of the hollow body 12 and that it is therefore necessary to intervene in order to change wearing components or make adjustments.

Optionally, the diagnostic method may also comprise an additional fourth prediction step “E4” which aims to estimate the number of cycles remaining for carrying out maintenance operations before the average “βₐᵥ” is lower than the determined second threshold “S2”. During this additional fourth prediction step “E4”, the averages “βₐᵥ” associated with said forming station 10 are recorded in a memory of the electronic control unit 50, and a criterion representative of the slope “β₂” of the average “βₐᵥ” as a function of time is calculated in each cycle. The electronic unit 50 then calculates, as a function of the slope “β₂” of the average “βₐᵥ”, a number of cycles remaining before the average “βₐᵥ” becomes lower than said second threshold “S2”.

For this additional fourth prediction step “E4”, the criterion representative of the slope “β₂” of the average “βₐᵥ” is calculated from a collection of averages “βₐᵥ” calculated over multiple successive determined periods. For example, when a determined period is set to 24 h, the slope “β₂” of the average “βₐᵥ” is calculated from a collection of averages “βₐᵥ” calculated over multiple days.

The additional fourth prediction step “E4” consists in this case in calculating the slope “β₂” of a straight line defined by fitting averages “βₐᵥ” as a function of time. This additional fourth prediction step “E4” is carried out automatically by the electronic control unit 50.

Like during the step “E2” of calculating a criterion representative of the rate of pressure drop, the fitting may be obtained by linear regression, in particular by the least squares method, or by other methods based for example on segmentation of values in order to use smoothing phenomena (for example the Mayer method or the median-median method).

In one exemplary embodiment, the slope “β₂” of the straight line is obtained by a linear regression method, such as the least squares method.

According to this method, each average “βₐᵥ” has coordinates:
“pᵢ” corresponding to the calculated average;
“qᵢ” corresponding to the determined period in which the average “βₐᵥ” was calculated.

The number “m” represents the number of determined periods taken into account to calculate the slope “β₂”.

The slope “β₂” of the straight line obtained by linear regression from all the measurements in the series will be given by the following formula: [Math 2]

$${β}_{2} = \frac{\sum {p}_{i} \sum {q}_{i} - m \sum {p}_{i} {q}_{i}}{{( \sum {p}_{i} )}^{2} - m \sum {p}_{i}^{2}}$$

The method of the invention thus makes it possible to very effectively detect a pierced hollow body 12, to detect the time at which it is necessary to effect a maintenance operation on a particular forming station and even to anticipate this time.

For example, it is possible to calculate the duration remaining before maintenance of a forming station 10 according to the following equation: [Math 3]

$${Time}_{before maintenance} = \frac{{S}_{2} - {β}_{1}}{{β}_{2}}$$

in which:
   “β₁” is the slope calculated during the step “E1” of determining the change in the forming fluid pressure for the current cycle, as has been defined above;
   “β₂” is the slope of the straight line calculated during the additional fourth prediction step “E4” for the last completed determined period;
   “S2” is the determined second threshold.

This operation is automatically implemented by the electronic control unit 50, for example on iteration of the method or at each start of a new determined period.

During the implementation of the method, the first step “E1” of determining the change in the pressure of the forming fluid and the second step “E2” of calculating a criterion representative of the rate of pressure drop are carried out in each production cycle performed by the associated forming station 10. The third step “E3” of calculating an average “βₐᵥ” is carried out solely at the end of each determined period, for example once per day. The additional fourth prediction step “E4” is carried out at the end of multiple successive determined periods, for example once per week.

This method is very precise because it is based on a series of measurements effected in each cycle, making it possible to calculate a very reliable and robust criterion which makes it possible to smooth the measurement errors due for example to transitory fluctuations in the forming fluid pressure in the hollow body 12 or to measurement noise of the pressure sensor.

Generally, the forming station 10 is arranged in a forming unit 54 comprising multiple identical forming stations 10. The forming unit 54 comprises, for example, a carousel 56, around the periphery of which multiple forming stations 10 are regularly distributed. The forming unit 54 comprises, for example, twenty forming stations 10. Such a forming unit 54 is used particularly in an installation for producing containers in very large batches, for example at a production rate of 60 000 containers per hour.

All the forming stations 10 are identical to the forming station 10 described above. Nonlimitingly, each source 22, 42 of pressurized forming fluid is common to all the forming stations 10 of the forming unit; by contrast, each forming station 10 comprises associated valves in order to be able to be controlled individually.

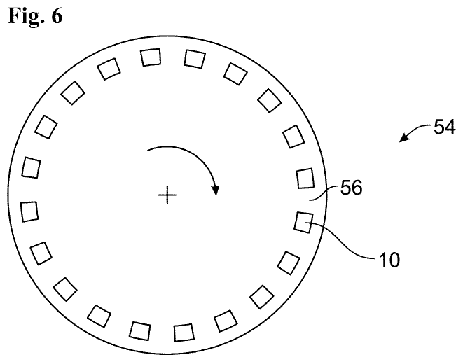

As shown in FIG. 6, the diagnostic method is advantageously implemented individually for each of the forming stations. In order to enable the electronic control unit 50 to associate the values calculated during a diagnostic method with the corresponding forming station 10, each forming station 10 is advantageously identified by a unique identifier.

Thus, the criterion representative of the pressure drop calculated during the second step “E2” of calculating a criterion representative of the rate of pressure drop is stored in each cycle in a manner matched to the identifier of the associated forming station 10 in order to allow individual monitoring of each forming station 10.

Similarly, the average “βₐᵥ” calculated during the third step “E3” of calculating an average “βₐᵥ” is recorded in a memory of the electronic control unit 50 in a manner matched to the identifier of the associated forming station 10.

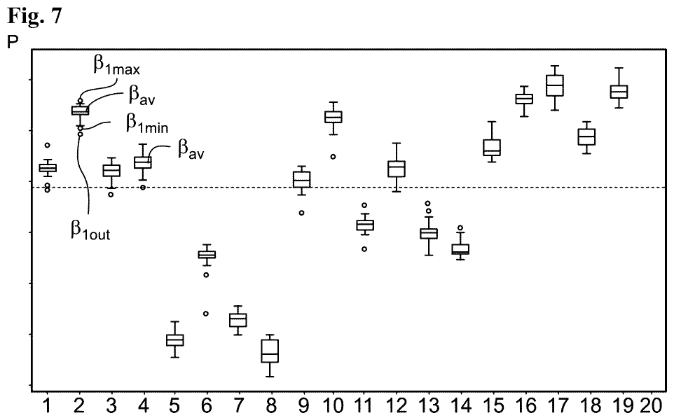

As shown in FIG. 7, each forming station 10 is identified by a number. For each forming station 10, there is the average “βₐᵥ”, extreme values “β₁ₘₐₓ” and “β₁ₘᵢₙ” in the collection and potentially slope values “β₁ₒᵤₜ” which are considered to be too far from the average “βₐᵥ” and are therefore not retained for the calculation thereof.

It is therefore possible to know at all times the individual sealing characteristics of each forming station 10. This makes it possible to intervene at the optimal time to minimize the number of maintenance operations.

This thus makes it possible to save on pressurized forming fluid and, consequently, energy.

This advantage is all the greater when it is combined with the advantages obtained by recycling part of the pressurized forming fluid.

In the example shown in FIG. 1, the source of forming fluid at the pre-blowing pressure Pfp comprises a reservoir 58 for storing pressurized forming fluid that is connected to the blowing nozzle 18 by way of the associated pre-blowing valve 46. Said storage reservoir 58 comprises forming fluid stored at a pressure Ps greater than or equal to the pre-blowing pressure Pfp. In order to deliver the forming fluid at the pre-blowing pressure Pfp, the pre-blowing source further comprises a pressure regulator 60 which reduces the pressure of the forming fluid from its storage pressure Ps to its pre-blowing pressure Pfp.

The blowing nozzle 18 is also connected to said storage reservoir 58 by way of a recovery line 62 in which a recovery valve 64 is interposed. This makes it possible to reuse part of the pressurized forming fluid contained in the hollow body 12 at the end of the forming thereof in order to participate in the forming of a subsequent hollow body 12 into a final container. This notably reduces the overall energy expenditure for producing a final container.

A filter 66 is advantageously interposed in the recovery line 62 in order to prevent contaminating particles from being reintroduced into a hollow body 12 during a next blowing operation.

Thus, the third depressurization phase “P3” described above comprises in this case a first subphase “P3-1” of discharging the pressurized forming fluid from the hollow body 12 to the storage reservoir 58 by opening of the recovery valve 64.

When the pressure in the hollow body 12 has dropped to a pressure slightly greater than the storage pressure Ps, a second subphase “P3-2” is triggered. The recovery valve 64 is then closed and the exhaust valve 32 is opened in order to allow the rest of the forming fluid to escape to the atmosphere until the pressure inside the hollow body 12 is substantially equal to atmospheric pressure Patm.

1. A method for diagnosing a forming fluid leak in at least one forming station for forming hollow bodies made of thermoplastic material during a production cycle sequence, the method comprising:
in a first phase (P1), pressurizing the hollow body by connection to a source of forming fluid compressed to a maximum blowing pressure via a blowing valve (26);
in a second phase (P2), passively maintaining pressurization during which second phase the hollow body is isolated from the forming fluid source by closure of the blowing valve;
in a third phase (P3), depressurizing the hollow body, wherein the third phase (P3) is triggered at the end of the second phase (P2);
wherein the method further comprises a determining step (E1) of determining a change in pressure of the forming fluid in the hollow body by carrying out a series of multiple pressure measurements successively during the second phase (P2).

2. The method as claimed in claim 1, wherein the determining step (E1) is followed by a first calculating step (E2) of calculating a criterion representative of a rate of pressure drop in the hollow body during the second phase (P2), wherein the calculating is based on the multiple pressure measurements taken during the determining step (E1).

3. The method as claimed in claim 2, wherein the first calculating step (E2) comprises calculating a slope (β₁) of a straight line, wherein the straight line is defined by fitting measurements of the forming fluid pressure as a function of time.

4. The method as claimed in claim 3, wherein the slope (β₁) of the straight line is obtained by a linear regression method.

5. The method as claimed in claim 3, wherein a value of a particular slope (β₁) is associated with the forming station during a current cycle is recorded in a memory of an electronic control unit, the method further comprising a second calculating step (E3) of calculating an average (βₐᵥ) of a plurality of slopes (β₁) recorded during a determined period.

6. The method as claimed in claim 2, wherein when the criterion calculated in a cycle is representative of a pressure drop below a determined first threshold (S1), the hollow body formed during the cycle is ejected as scrap.

7. The method as claimed in claim 5, further comprising emitting a signal from the electronic control unit when the average (βₐᵥ) calculated during the second calculating step (E3) is lower than a determined second threshold (S2), and wherein the signal indicates a need for maintenance of the forming station.

8. The method as claimed in claim 7, wherein the averages (βₐᵥ) associated with the forming station are recorded in a memory of the electronic control unit,
the method comprising a prediction step (E4) in which a criterion representative of the slope (β₂) of the averages (βₐᵥ) as a function of time is calculated in each cycle,
then the electronic control unit calculating a number of cycles remaining before the average (βₐᵥ) becomes lower than the second determined threshold (S2), wherein the calculation is a function of the slope of the averages (βₐᵥ).

9. The method as claimed in claim 5, further comprising applying the method to each forming station of a forming unit, the forming unit comprising a plurality of forming stations, wherein the criterion representative of the pressure drop calculated during the first calculating step (E2) is stored in each cycle and matched to an identifier of an associated forming station in order to allow individual monitoring of each forming station.

10. The method as claimed in claim 9, wherein the average (βₐᵥ) calculated during the second calculating step (E3) is recorded in a memory of the electronic control unit in a manner matched to the identifier of the associated forming station.

11. The method as claimed in claim 1, wherein, during the determining step (E1), the first measurement in the series is effected after a determined delay (d1), from the emission of a signal for closing the blowing valve, wherein the signal marks the end of the first phase (P1).

12. The method as claimed in claim 1, wherein, during the determining step (E1), the measurements in the series are carried out with a frequency of the order of a thousandth of a second.

13. The method as claimed in any claim 1, wherein a duration of the second phase (P2) is at least 40 milliseconds.

14. The method as claimed in claim 1, wherein the determining step (E1) ends when an electronic control unit emits a signal for opening a valve, enabling the start of depressurization of the hollow body.

15. The method as claimed in claim 1, wherein the multiple pressure measurements in the determining step (E1) are effected by a pressure sensor that emits to an electronic control unit a signal representative of the forming fluid pressure in the hollow body.

16. The method as claimed in claim 15, wherein the pressure sensor is arranged in a blowing nozzle of the forming station, said blowing nozzle configured to be connected in a fluidtight manner to the hollow body during forming.
